(19) United States
(12) Patent Application Publication
(10) Pub. No.: US 2013/0223364 A1
(43) Pub. Date: Aug. 29, 2013

(54) ACK CHANNEL DESIGN FOR EARLY TERMINATION OF R99 UPLINK TRAFFIC

(71) Applicant: QUALCOMM Incorporated, (US)

(72) Inventors: Sony J. Akkarakaran, San Diego, CA (US); Sharad Deepak Sambhwani, San Diego, CA (US)

(73) Assignee: QUALCOMM Incorporated, San Diego, CA (US)

(21) Appl. No.: 13/773,242

(22) Filed: Feb. 21, 2013

Related U.S. Application Data
(60) Provisional application No. 61/603,109, filed on Feb. 24, 2012.

(51) Int. Cl. H04W 72/04

(52) U.S. Cl. CPC H04W 72/04
USPC 370/329

(57) ABSTRACT

A method, an apparatus, and a computer program product for wireless communication are provided. The apparatus early decodes a packet prior to reception of the entire packet. Thereafter, the apparatus transmits an Ack of early decoding. A packet transmitting apparatus begins a transmission of a packet and ceases transmission of the packet after receiving an Ack of early decoding prior to transmission of the entire packet. The Ack may be transmitted using on/off keying or BPSK and using a slot format that substitutes Ack bits in a subset of slots reserved for ULTPC. The Ack may be transmitted using a separate R99 downlink channel by using resources of another existing downlink control channel.

### CLAIM OF PRIORITY UNDER 35 U.S.C. §119

The present application for patent claims priority to Provisional Application No. 61/603,109 entitled “Ack Channel Design For Early Termination of R99 Uplink Traffic” filed Feb. 24, 2012, and assigned to the assignee hereof and hereby expressly incorporated by reference herein.

### REFERENCE TO CO-PENDING APPLICATIONS FOR PATENT

The present application for patent is related to co-pending U.S. patent application “Method and System to Improve Frame Early Termination Success Rate” having Attorney Docket No. 121586, filed concurrently herewith, assigned to the assignee hereof, and expressly incorporated by reference herein.

The present application for patent is related to International Patent Application No. PCT/CN2012/071676 titled “Ack Channel Design for Early Termination of R99 Downlink Traffic” having Attorney Docket No. 121604, filed on Feb. 27, 2012, and International Patent Application No. PCT/CN2012/071938 titled “Ack Channel Design for Early Termination of R99 Downlink Traffic” having Attorney Docket No. 121698, filed on Mar. 5, 2012, both of which are assigned to the assignee hereof, and both of which are expressly incorporated by reference herein.

### BACKGROUND

1. Field

The present disclosure relates generally to communication systems, and more particularly, to a method, a computer program product, and an apparatus that include an acknowledgement of early decoding of a packet transmission.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Substantial system capacity gains and receiver power consumption reductions can be made possible through the use of early decoding. For example, system capacity gains can be possible when a transmitter is able to stop a packet transmission as soon as it is made aware that the receiver has succeeded in decoding the packet early. Receiver power consumption savings can also be possible because appropriate receiver subsystems can be powered down from the time of successful early decoding until the end of the packet duration.

In order to realize these capacity gains, the transmitter needs to a way to receive an indication from the receiver notifying it that the packet has been decoded prior to transmission of the entire packet. Thus, a fast and reliable feedback channel on which the receiver can inform the transmitter of the success or failure of its early decoding attempts is needed. Aspects presented herein provide the ability for a receiver to send such notification to the transmitter.

In an aspect of the disclosure, a method, a computer program product, and an apparatus are provided. The apparatus early decodes a packet prior to reception of the entire packet. Thereafter, the apparatus transmits an acknowledgement (Ack) of early decoding. The Ack may be transmitted using one of (a) on/off keying or BPSK and using a slot format that substitutes Ack bits in a subset of slots reserved for uplink transmitter power control (ULTPC) and (b) a separate R99 downlink (DL) channel.

Thus, in the first alternative, some or all of the ULTPC bits, in a slot having bits reserved for ULTPC, can be substituted with Ack bits. Typically, ULTPC bits are present in every slot. Thus, the substitution may occur in a subset of such slots.

In the second alternative, an Ack can be sent using a separate R99 DL channel, e.g., a DL fractional dedicated physical channel (F-DPCH) or a downlink enhanced dedicated channel hybrid automatic repeat request acknowledgement indicator channel (E-HICH). The Ack may be transmitted using, e.g., resources of another existing downlink channel.

In both alternatives, the Ack can be used to acknowledge traffic sent on an uplink R99 channel.

In another aspect of the disclosure, a method, a computer program product, and an apparatus are provided. The apparatus begins a transmission of a packet and ceases transmission of the packet after receiving an Ack of early decoding prior to transmission of the entire packet. The Ack may be received as a transmission using one of (a) on/off keying or binary phase-shift keying (BPSK) and using a slot format that substitutes Ack bits in a subset of slots reserved for ULTPC and (b) a separate R99 DL channel. This separate DL channel may comprise a DL fractional dedicated physical channel (F-DPCH) or a downlink enhanced dedicated channel hybrid automatic repeat request acknowledgement indicator channel (E-HICH). The Ack may be transmitted using, e.g., resources of another existing downlink channel. In both alternatives, the Ack can be used to acknowledge traffic sent on an uplink R99 channel.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a hardware implementation for an apparatus employing a processing system.

FIG. 2 is a block diagram conceptually illustrating an example of a telecommunications system.

FIG. 3 is a conceptual diagram illustrating an example of an access network.

FIG. 4 is a block diagram conceptually illustrating an example of a Node B in communication with a UE in a telecommunications system.

FIG. 5 is a flow chart of a method of wireless communication.

FIG. 6 is a flow chart of a method of wireless communication.

FIG. 7 is a conceptual data flow diagram illustrating the data flow between different modules/means/components in an exemplary apparatus.

FIG. 8 is a conceptual data flow diagram illustrating the data flow between different modules/means/components in an exemplary apparatus.

FIG. 9 is a diagram illustrating an example of a hardware implementation for an apparatus employing a processing system

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the DL and SC-FDMA on the UL. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

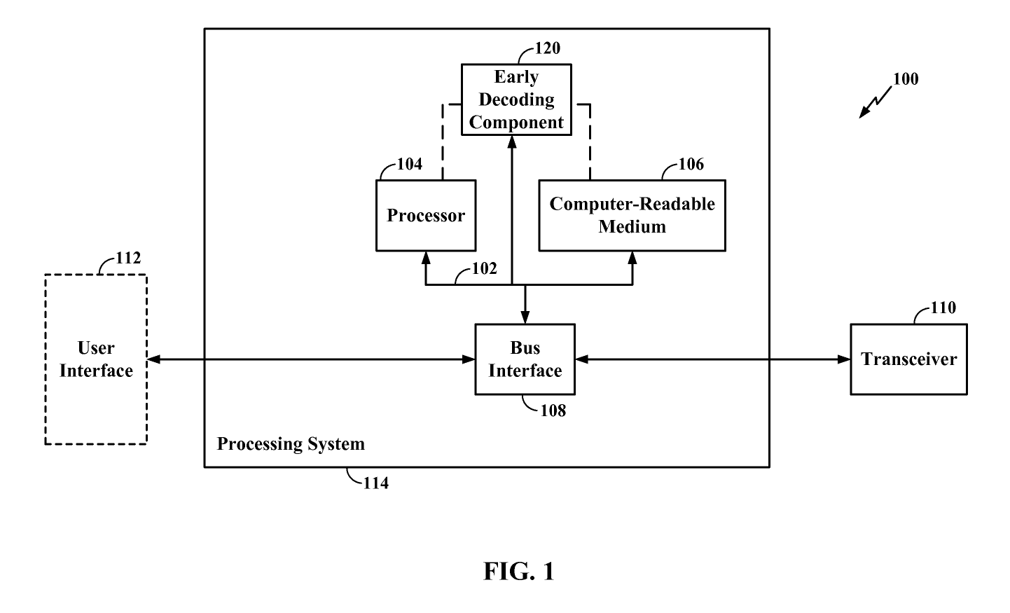

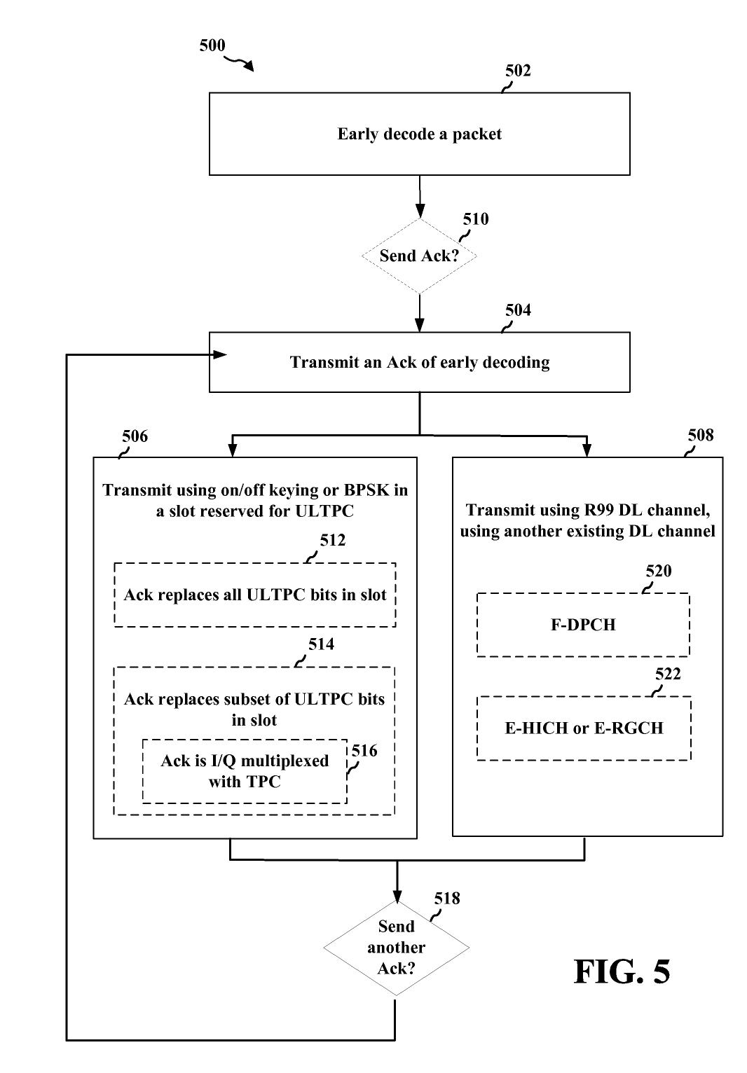

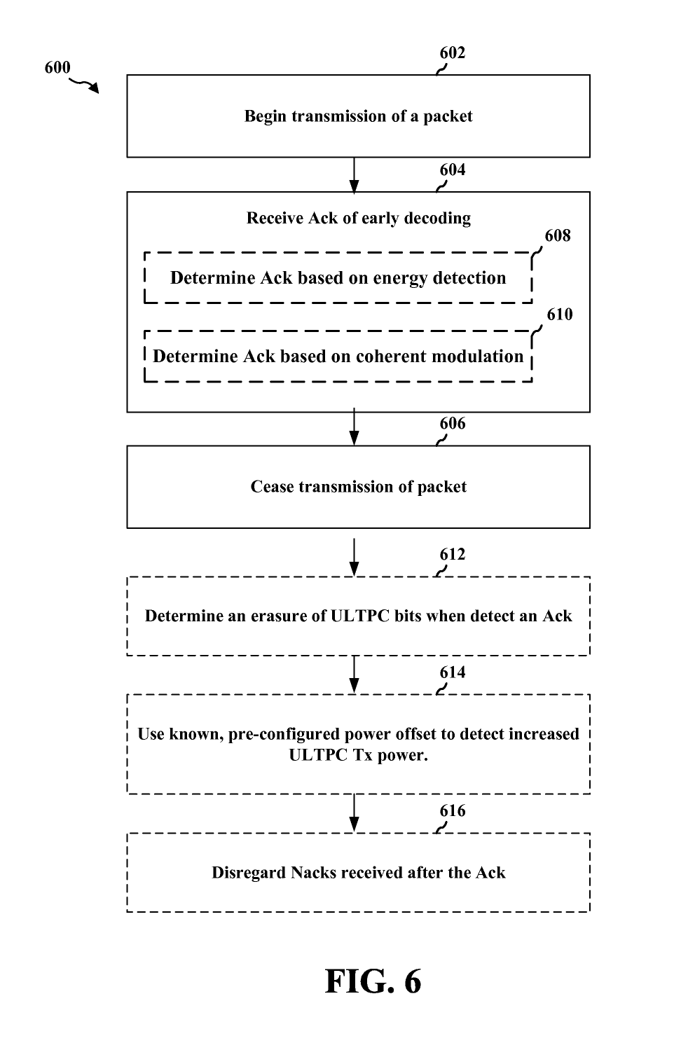

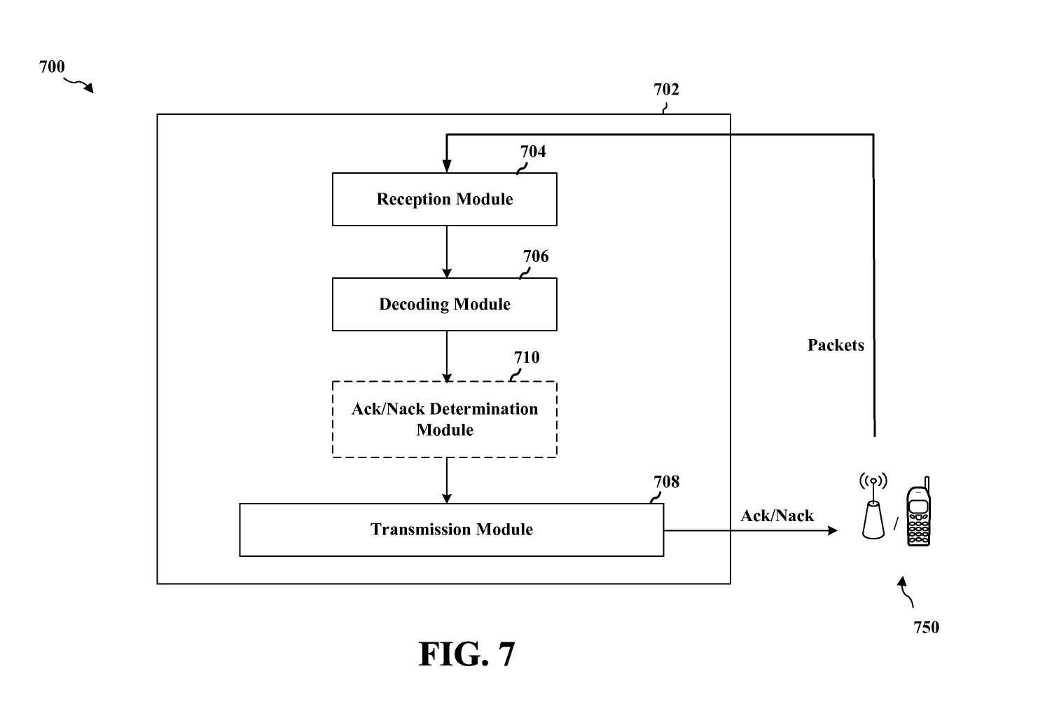

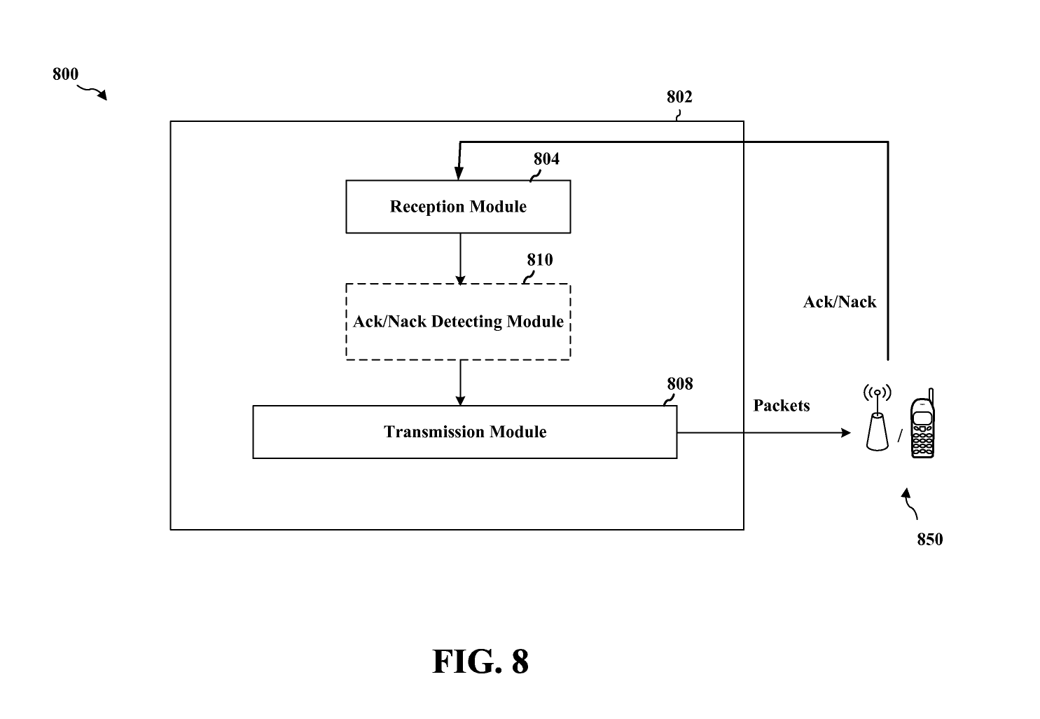

FIG. 1 is a conceptual diagram illustrating an example of a hardware implementation for an apparatus 100 employing a processing system 114. The processing system may further include an early decoding component 120 that is configured to transmit and receive Acks of early decoding. For example, the early decoding component may include Ack transmission functions similar to those described in connection with FIGS. 5 and 7 and/or Ack reception functions similar to those described in connection with FIGS. 6 and 8. In some aspects, early decoding component 120 may be a stand-alone component within processing system 114, or may be defined by one or more processing modules within processor 104, or by executable code or instructions stored as computer-readable medium 106 and executable by processor 104, or some combination thereof.

For example, aspects of the Ack transmission function of the early decoding component 120 may transmit an Ack of early decoding after early decoding a packet prior to reception of the entire packet. The Ack may be transmitted using one of (a) on/off keying or BPSK and using a slot format that substitutes Ack bits in a subset of slots reserved for ULTPC and (b) a separate R99 DL channel.

Thus, in the first alternative, some or all of the ULTPC bits can be substituted with Ack bits. Typically, ULTPC bits are present in every slot. Thus, the substitution may occur in a subset of the slots.

In the second alternative, an Ack can be sent using a separate R99 DL channel, e.g., a DL F-DPCH or a DL E-HICH. The Ack is transmitted using, e.g., resources of another existing downlink channel.

In both alternatives, the Ack can be used to acknowledge traffic sent on an uplink R99 channel.

Aspects of the Ack reception function of the early decoding component 120 may receive an Ack of early decoding after beginning a transmission of a packet. The Ack may be received prior to transmission of the entire packet. Once the Ack is received, transmission of the packet can be ceased. The Ack may be received as a transmission using one of (a) on/off keying or BPSK and using a slot format that substitutes Ack bits in a subset of slots reserved for ULTPC and (b) a separate R99 DL channel. The Ack can be transmitted using resources of another existing downlink channel, e.g., an F-DPCH or E-HICH.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

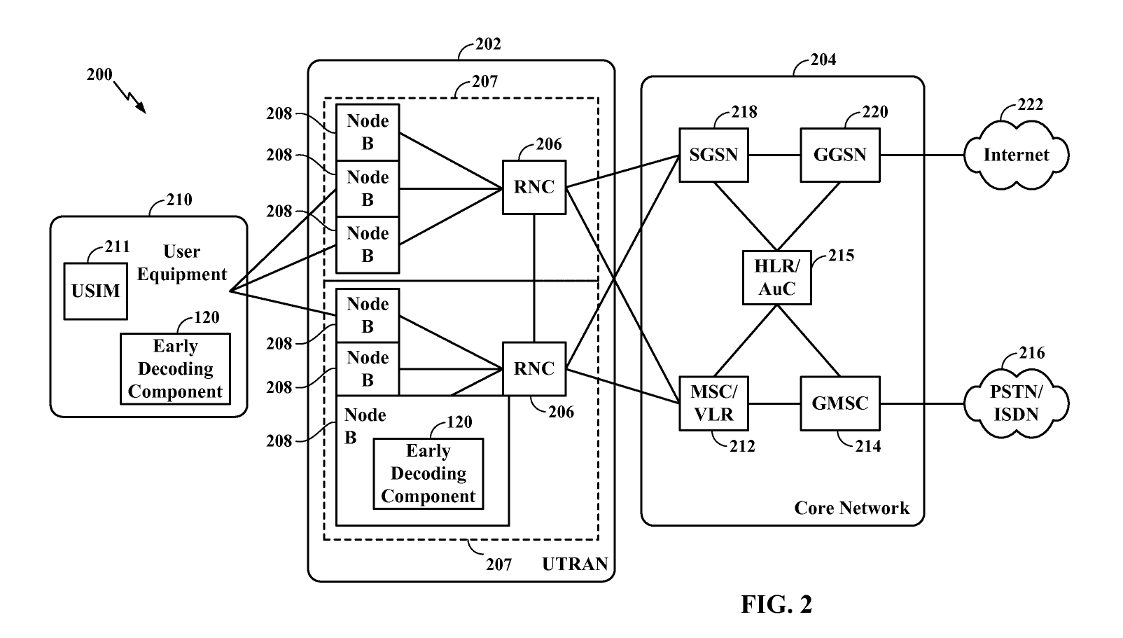

The various concepts presented throughout this disclosure may be implemented across a broad variety of telecommunication systems, network architectures, and communication standards. By way of example and without limitation, the aspects of the present disclosure illustrated in FIG. 2 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. Either the Node B 208 or the UE 210 may be, e.g., apparatus 702 or 802 in FIGS. 7 and 8, respectively. In the instant specification, the PHY layer may be considered layer 1; the MAC layer may be considered layer 2; and the RRC layer may be considered layer 3. Information hereinbelow utilizes terminology introduced in Radio Resource Control (RRC) Protocol Specification, 3GPP TS 25.331 v9.1.0, incorporated herein by reference. The UE 210 may include an early decoding component 120, as described in connection with FIG. 1.

The geographic region covered by the SRNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each SRNS 207; however, the SRNSs 207 may include any number of wireless Node Bs. The Node Bs 208 provide wireless access points to a core network (CN) 204 for any number of UEs 210. Although only one Node B is illustrated as having an early decoding component 120, as described in connection with FIG. 1, each of the Node Bs 120 may include such a component. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The core network 204 interfaces with one or more access networks, such as the UTRAN 202. As shown, the core network 204 is a GSM core network. However, as those skilled in the art will recognize, the various concepts presented throughout this disclosure may be implemented in a RAN, or other suitable access network, to provide UEs with access to types of core networks other than GSM networks.

The core network 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The core network 204 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

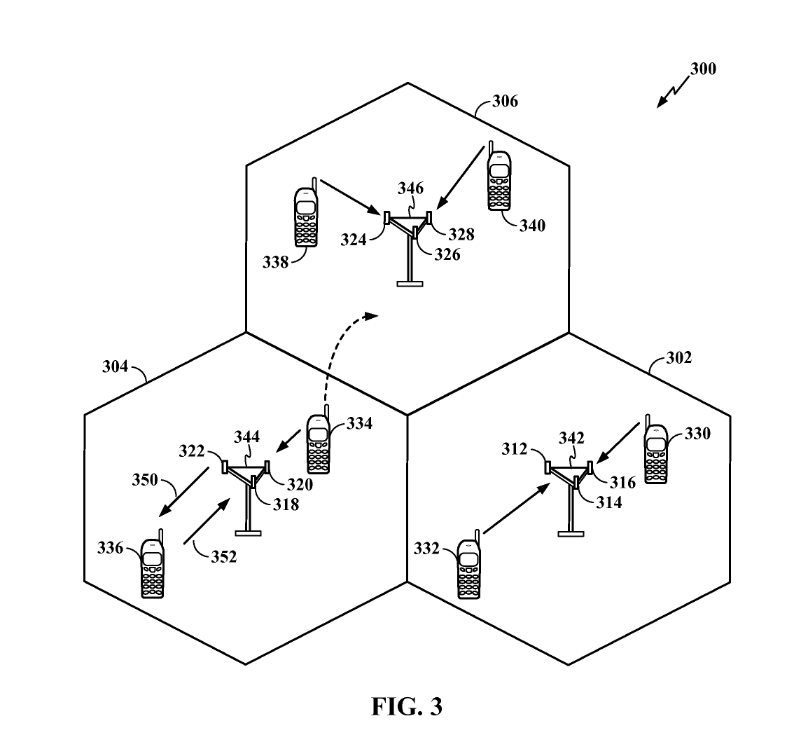

Referring to FIG. 3, an access network 300 in a UTRAN architecture is illustrated. The multiple access wireless communication system includes multiple cellular regions (cells), including cells 302, 304, and 306, each of which may include one or more sectors. Aspects of early decoding and Ack transmission, as described in connection with FIGS. 5-9, including early decoding component 120 of FIG. 1 may be employed in communication between UEs 330, 332, 334, 336, 338, and 340 and cells 302, 304, and 306. For example, a UE 336 may receive a packet transmission 350 from transmitter 344. The UE may attempt to early decode the packet transmission 350 prior to receive the entire packet transmission 350. Once the UE has successfully early decoded the packet transmission, the UE may transmit an Ack 352 to the transmitter 344. This enables the transmitter to cease transmission of the packet transmission, thereby providing system capacity gains.

The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a core network 204 (see FIG. 2) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 2), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a DL dedicated physical channel DPCH or fractional DL dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

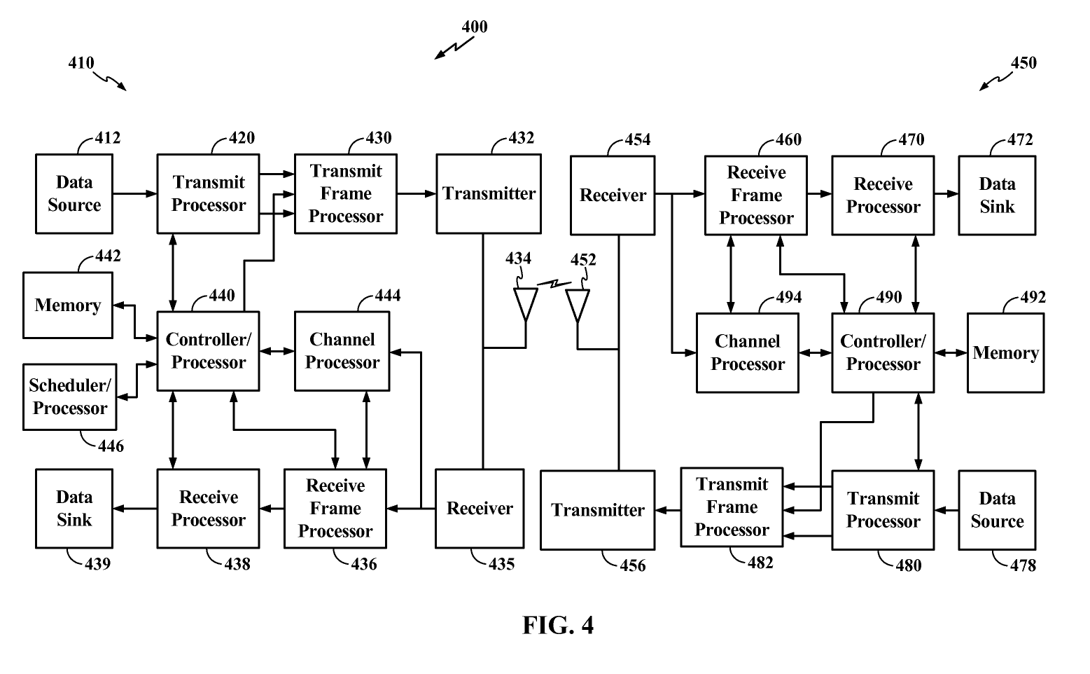

FIG. 4 is a block diagram of a Node B 410 in communication with a UE 450, where the Node B 410 may be the Node B 208 in FIG. 2, and the UE 450 may be the UE 210 in FIG. 2. As described herein, in Node B 410, the Ack transmission function of early decoding component 120 of FIGS. 1 and 2, may include any or the TX Processor 420, the TX Frame Processor, and the controller/processor 440. The Ack reception function of the early decoding component of Node B 410 may include any of the RX Processor 438, the RX Frame Processor, and the controller/processor 440. In UE 450, the Ack transmission function of the early decoding component 120 of FIGS. 1 and 2 may include any of the TX Processor 480, the Transmit Frame Processor 482, and Controller/processor 490. The Ack reception function of the early decoding component 120 in UE 450 may include any of the RX Processor 470, the RX Frame Processor 460, and the controller/processor 490.

In the DL communication, a transmit processor 420 may receive data from a data source 412 and control signals from a controller/processor 440. The transmit processor 420 provides various signal processing functions for the data and control signals, as well as reference signals (e.g., pilot signals). For example, the transmit processor 420 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 444 may be used by a controller/processor 440 to determine the coding, modulation, spreading, and/or scrambling schemes for the transmit processor 420. These channel estimates may be derived from a reference signal transmitted by the UE 450 or from feedback from the UE 450. The symbols generated by the transmit processor 420 are provided to a transmit frame processor 430 to create a frame structure. The transmit frame processor 430 creates this frame structure by multiplexing the symbols with information from the controller/processor 440, resulting in a series of frames. The frames are then provided to a transmitter 432, which provides various signal conditioning functions including amplifying, filtering, and modulating the frames onto a carrier for DL transmission over the wireless medium through antenna 434. The antenna 434 may include one or more antennas, for example, including beam steering bidirectional adaptive antenna arrays or other similar beam technologies.

At the UE 450, a receiver 454 receives the DL transmission through an antenna 452 and processes the transmission to recover the information modulated onto the carrier. The information recovered by the receiver 454 is provided to a receive frame processor 460, which parses each frame, and provides information from the frames to a channel processor 494 and the data, control, and reference signals to a receive processor 470. The receive processor 470 then performs the inverse of the processing performed by the transmit processor 420 in the Node B 410. More specifically, the receive processor 470 descrambles and despreads the symbols, and then determines the most likely signal constellation points transmitted by the Node B 410 based on the modulation scheme. These soft decisions may be based on channel estimates computed by the channel processor 494. The soft decisions are then decoded and deinterleaved to recover the data, control, and reference signals. The CRC codes are then checked to determine whether the frames were successfully decoded. The data carried by the successfully decoded frames will then be provided to a data sink 472, which represents applications running in the UE 450 and/or various user interfaces (e.g., display). Control signals carried by successfully decoded frames will be provided to a controller/processor 490. When frames are unsuccessfully decoded by the receiver processor 470, the controller/processor 490 may also use an acknowledgement (ACK) and/or negative acknowledgement (NACK) protocol to support retransmission requests for those frames.

In the UL, data from a data source 478 and control signals from the controller/processor 490 are provided to a transmit processor 480. The data source 478 may represent applications running in the UE 450 and various user interfaces (e.g., keyboard). Similar to the functionality described in connection with the DL transmission by the Node B 410, the transmit processor 480 provides various signal processing functions including CRC codes, coding and interleaving to facilitate FEC, mapping to signal constellations, spreading with OVSFs, and scrambling to produce a series of symbols. Channel estimates, derived by the channel processor 494 from a reference signal transmitted by the Node B 410 or from feedback contained in the midamble transmitted by the Node B 410, may be used to select the appropriate coding, modulation, spreading, and/or scrambling schemes. The symbols produced by the transmit processor 480 will be provided to a transmit frame processor 482 to create a frame structure. The transmit frame processor 482 creates this frame structure by multiplexing the symbols with information from the controller/processor 490, resulting in a series of frames. The frames are then provided to a transmitter 456, which provides various signal conditioning functions including amplification, filtering, and modulating the frames onto a carrier for UL transmission over the wireless medium through the antenna 452.

The UL transmission is processed at the Node B 410 in a manner similar to that described in connection with the receiver function at the UE 450. A receiver 435 receives the UL transmission through the antenna 434 and processes the transmission to recover the information modulated onto the carrier. The information recovered by the receiver 435 is provided to a receive frame processor 436, which parses each frame, and provides information from the frames to the channel processor 444 and the data, control, and reference signals to a receive processor 438. The receive processor 438 performs the inverse of the processing performed by the transmit processor 480 in the UE 450. The data and control signals carried by the successfully decoded frames may then be provided to a data sink 439 and the controller/processor, respectively. If some of the frames were unsuccessfully decoded by the receive processor, the controller/processor 440 may also use an acknowledgement (ACK) and/or negative acknowledgement (NACK) protocol to support retransmission requests for those frames.

The controller/processors 440 and 490 may be used to direct the operation at the Node B 410 and the UE 450, respectively. For example, the controller/processors 440 and 490 may provide various functions including timing, peripheral interfaces, voltage regulation, power management, and other control functions. The computer readable media of memories 442 and 492 may store data and software for the Node B 410 and the UE 450, respectively. A scheduler/processor 446 at the Node B 410 may be used to allocate resources to the UEs and schedule DL and/or UL transmissions for the UEs.

Substantial system capacity gains and receiver power consumption reductions can be made possible through the use of early decoding. For example, system capacity gains can be possible when a transmitter is able to stop a packet transmission as soon as it is made aware that the receiver has succeeded in decoding the packet early. Receiver power consumption savings can also be possible because appropriate receiver subsystems can be powered down from the time of successful early decoding until the end of the packet duration.

In order to realize these capacity gains, the transmitter needs to a way to receive an indication from the receiver notifying it that the packet has been decoded prior to transmission of the entire packet. Thus, a fast and reliable feedback channel on which the receiver can inform the transmitter of the success or failure of its early decoding attempts is needed.

International Application No. PCT/CN2009/075179 (WO2011/063569) entitled “Increasing Capacity in Wireless Communications,” the entire contents of which are hereby incorporated by reference herein, outlined time division multiplexing (TDM) and code division multiplexing (CDM) approaches to design of an Ack channel.

Aspects presented herein provide additional implementation aspects for such TDM and CDM approaches. Additional aspects presented herein provide an alternative approach involving in-phase-quadrature phase (I-Q) multiplexing. Further aspects presented herein provide solutions to some issues that arise in these implementations in the context of R99 transmissions.

R99 packets that are transmitted over time durations, e.g., transmission time intervals (TTIs), of 10 ms, 20 ms, 40 ms or 80 ms may be decodable by the receiver prior to reception of the entire packet. Once decoded, an Ack can be sent via an Ack channel in order to notify the device transmitting the R99 packet to cease transmission.

The Ack channel can be transmitted using on-off keying in order to reduce its power requirement. Through the use of such on-off keying, “off” transmissions that are sent with zero power represent a negative acknowledgment (Nack) until an “on” transmission is sent at a pre-configured power to represent a positive acknowledgment (Ack). The Ack channel can also be transmitted using BPSK. In this approach different symbols, and possibly different power levels, can be used to indicate Ack and Nack. In slots where Ack/Nack signaling is disallowed, no signaling is sent. BPSK results in lower power if the probabilities of sending Ack and Nack are not very disparate, e.g., due to restriction of the time-slots in which Ack/Nack signaling is allowed. Additional aspects of such a BPSK approach are described in International Application No. PCT/CN2012/071938 entitled “Ack Channel Design For Early Termination of R99 Downlink Traffic” filed Mar. 5, 2012, the entire contents of which are expressly incorporated herein by reference.

On-of keying may be preferable when a Nack is much more likely than an Ack, because it saves power when sending a Nack. However, an Ack may be more likely toward the end of a packet transmission. Therefore, it may be preferable to use BPSK in transmitting Acks toward the end of a packet transmission.

In one aspect, ‘off’ transmissions may be sent after an ‘on’ transmission until the end of the packet. These ‘off’ transmissions do not signify Nack, but are rather intended to be ignored since the packet has already been acknowledged. This reduces the transmission power required to send the acknowledgement. In another aspect, the Ack may be sent multiple times per packet, in order to increase the reliability of its reception. In yet another aspect, the Ack may be repeated only when it is determined that the original Ack transmission was not received correctly. Such a determination can be made by continued monitoring of the energy of the received packet even after it has been decoded, in order to determine whether the transmitter has stopped the packet transmission in response to the Ack. Although the Ack transmission may use on-off signalling, the receiver subsystem detecting the Ack/Nack at the packet transmitter need not be based only on energy detection. The receiver subsystem may also employ coherent demodulation using channel estimates, such as those used for demodulation of other control and data channels.

In any of these aspects, a decision could also be made whether to avoid sending an Ack even though the packet was decoded, based on other criteria. For example, the receiver may determine not to send an Ack even though it has early decoded the packet transmission when the transmitter that would send the Ack is close to its maximum power limit. The receiver may also determine not to send an Ack, even though it has early decoded the packet transmission, when the packet is only decoded very near to its completion. For example, the UE may make this determination when the amount of time for which the packet transmission could be stopped, after accounting for the delay in receiving the Ack, would be very small or zero.

Another aspect for an Ack channel sent on the DL to acknowledge packets received on the UL may include a TDM design in which certain time durations on the DL R99 DPCH channel are reserved for sending the Ack/Nack information. For example, the reserved time durations reserved may include a subset of those normally used to send ULTPC bits. The ULTPC bits are currently sent every slot. Therefore, e.g., every alternate slot could be reserved for Ack/Nack instead of ULTPC.

Reserving alternate ULTPC slots for Ack/Nack reduces the UL power-control rate by a factor of one half, which may affect the UL performance. The UL performance impact may be reduced by re-optimizations that account for the reduced power-control rate. These optimizations may include configuration parameters such as the power-control step size as well as UL receiver algorithms and their parameters, such as the filter coefficients for the power-control SNR estimation filter.

The ULTPC bits may also be used by the DL receiver for other purposes, such as SNR estimation for DL power control, so reducing the ULTPC bit rate could impact these other uses as well. These impacts can be reduced by re-optimizing configuration parameters such as the DL power control stepsize, and DL receiver parameters such as the DL SNR estimation filter coefficients, to account for the reduced ULTPC bit rate. The ULTPC bit rate reduction impacts could also be reduced by reserving a smaller subset of the ULTPC bit positions for the Ack/Nack. This creates a non-uniform rate UL power control with a higher average power-control rate than that obtained by reserving every alternate slot ULTPC for Ack/Nack. This trades off an UL power-control rate for Ack delay, since fewer Ack opportunities implies that the receiver may have to wait longer before it can send the Ack.

In the current specification, the number of ULTPC bits per slot is always even. Thus, aspects may include using half of them for ULTPC and the other half for Ack/Nack. For example, the ULTPC and the Ack can be I-Q multiplexed in each slot.

Typically, when there are two TPC bits in a slot, and one of them is replaced by Ack, the TPC and Ack can be I-Q multiplexed, as in the traditional interpretation of I-Q multiplexing (e.g., one bit on I and one bit on Q). However, the 2 TPC bit positions both have the same value, implying that the TPC uses a 45 degree rotated BPSK constellation. Another way of achieving the I-Q multiplexing is to add a new Ack symbol, which uses its own BPSK or on-off keying constellation, and which is a further 90 degree rotated version of the typical TPC BPSK constellation. These example implementations of I-Q-multiplexing are similar, except that one has a fixed overall phase-shift of the constellation relative to the other.

Thus, the bits may comprise a constellation, and a fixed, known phaseshift may be added to the constellation after the bits are I-Q multiplexed. The fixed, known phaseshift may be, e.g., 45 degrees.

I-Q multiplexing preserves the UL power-control rate, but impacts the ULTPC demodulation performance instead. This impact can be eliminated by appropriately increasing the ULTPC transmit power to compensate for the reduced number of ULTPC bits. This does not affect the ULTPC bit decoding performance when a Nack has to be sent, if on-off keying is used. However, when an Ack has to be sent, receiver imperfections such as channel estimation errors, frequency offsets and I-Q phase imbalances may cause degradation in the ULTPC bit demodulation. This degradation may be acceptable as it only happens infrequently, because Ack can be sent only once or a few times per packet, as described above. This degradation may be further reduced by declaring a ULTPC bit erasure whenever an Ack is detected. Another way to reduce this degradation may be to transmit the ULTPC bit with a higher power in the slots where Ack needs to be sent, as compared to the power used in slots where Nack needs to be sent. The difference between these powers may be known to the receiver and can thus be accounted for in other algorithms that may use the ULTPC bits, e.g., signal-to-noise ratio (SNR) estimation for DL power control.

In general the above approaches may be described as creating a new slot-format that allows the Ack transmission, and defining the subset of slots that will use the newly created slot-format.

Another approach for the Ack channel design is a CDM approach, in which the Ack/Nack is sent on a different channel that uses a separate spreading code. This has the advantage of keeping the transmission of the UL TPC bits on the DL undisturbed, at the expense of using an additional code resource. However, the new code resource need not be exclusively for the Ack/Nack channel, other already existing control channels may be modified to accommodate the Ack/Nack channel. For example, some bit positions on the fractional dedicated physical channel (F-DPCH), or some signature sequences on enhanced dedicated channel hybrid automatic repeat request acknowledgement indicator channel (E-HICH) or enhanced dedicated channel relative grant channel (E-RGCH) can be reserved for transmitting the Ack/Nack information.

The above discussed methods may be implemented for example in the UE receiver and/or Node B transmitter as appropriate. Further, the present invention may involve a standards change.

FIG. 5 is a flow chart of a method 500 of wireless communication. The method may be performed by a wireless device that receives wireless communication, such as a UE or Node B. In an aspect, the device may be an apparatus 702 as described in connection with FIG. 7. The device may receive the wireless communication from a packet transmitting device such as a Node B or UE, e.g., 750 in FIG. 7 or 802 in FIG. 8. At 502, the device early decodes a packet prior to reception of the entire packet. In an aspect, the packet may be received via a reception module, e.g., 704 illustrated in FIG. 7. The decoding may then be performed by a decoding module, e.g., 706 illustrated in FIG. 7.

At 504, the device transmits an Ack of early decoding. The Ack may be transmitted, e.g., using one of two transmission mechanisms. The Ack can be transmitted at 506 using on/off keying or BPSK and using a slot format that substitutes Ack bits in a subset of slots reserved for ULTPC. A selection of one of on-off keying and BPSK may be based on at least one of a type of the packet being acknowledged and a time that the Ack is transmitted. This Ack may be transmitted at 506 on an R99 DL channel, and the packet that is early decoded may be received on an R99 UL channel.

Alternately, the Ack can be transmitted at 508 using separate R99 DL channel e.g., by using resources of another existing DL control channel.

In an aspect, this transmission of an Ack may be performed by a transmission module, e.g., 708 illustrated in FIG. 7.

As an option, which is indicated by having a dashed line, the device may determine at 510 whether or not to transmit an Ack after performing the early decoding. As illustrated, the determination can be made prior to transmission of the Ack at 504. In an aspect, this determination may be performed by an Ack/Nack determination module, e.g., 710 illustrated in FIG. 710.

The determination may be based on whether sufficient transmit power is available to transmit the Ack. For example, the device might decide not to transmit the Ack when the device's transmitter, which will transmit the Ack, is already functioning close to its maximum power limit.

The determination may be based on whether the Ack will be received with enough time to benefit from stopping the transmission. For example, the device might determine not to send an Ack when the packet is only decoded very near to its completion. For example, when the Ack will be received within less than a predetermined time period from the end of the transmission of the packet, the device may determine to refrain from sending the Ack. This avoids requiring the device to send an Ack when the amount of time for which packet transmission could be stopped is very small or zero. The determination may account for an amount of time used to decode the packet and an amount of time required for the transmitter transmitting the packet to receive the Ack.

When the Ack is transmitted using on/off keying or BPSK and using the slot format that substitutes Ack bits in a subset of slots having bits reserved for ULTPC, e.g., at 506, the Ack bits may replace all of a set of TPC bits, as at 512, or a subset of TPC bits, as at 514, of a slot reserved for ULTPC bits. Each slot typically carries bits reserved for ULTPC in additional to other data and control bits. Thus, a subset of bits in a subset of slots in a packet may be replaced with Ack bits. The use of on/off keying reduces the power requirement of an Ack channel. On/off keying may include negative Acks (Nacks) being communicated as “Off” transmissions, e.g., being sent with zero power. A positive Ack can be sent as an “On” transmission may be transmitted at a pre-configured power level. Although the Ack transmission may use on-off signaling, the packet transmitting device that receives the Ack may detect the Ack/Nack based only on energy detection, and may also detect the Ack/Nack using coherent demodulation using channel estimates. In another approach, the Ack transmission may use BPSK.

When the Ack bits replace all of a set of TPC bits in a slot, as at 512, the Ack may replace sets of ULTPC bits in alternate slots. This may reduce the UL power control rate a factor of one half, which may affect the UL performance. As described supra, the potential UL performance degradation can be addressed by applying re-optimizations that account for the reduced power-control rate. The optimizations may include adjusting configuration parameters such as the power-control step size and the UL receiver algorithms and their parameters. Such UL receiver parameters may include the filter coefficients for the power-control SNR estimation filter. As, the ULTPC bits may also be used by the DL receiver for other purposes, such as SNR estimation for DL power control, reducing the ULTPC bit rate could also impact these other uses. These impacts can be reduced by re-optimizing configuration parameters such as the DL power control stepsize, and DL receiver parameters such as the DL SNR estimation filter coefficients, in order to account for the reduced ULTPC bit rate.

Aspects of the ULTPC bit rate reduction impact can also be addressed by replacing ULTPC bits in fewer slots with an Ack. For example, the Ack may replace ULTPC bits in at most every third slot having bits reserved for ULTPC. This creates a non-uniform rate UL power control with a higher average power-control rate than that obtained by reserving every alternate slot ULTPC for Ack/Nack. This trades off UL power-control rate for Ack delay, because fewer Ack opportunities may cause the device to wait longer before it can send the Ack.

When the Ack bits replace only a subset of TPC bits in a slot, as at 514, the subset of the TPC bits replaced by Ack bits may comprise one half of the bits. These Ack bits may be I-Q multiplexed with the remaining half of the TPC bits at 516. In the current specification, the number of ULTPC bits per slot is always even, which enables half to be replaced by Ack/Nack bits.

The I/Q multiplexing of Ack/Nack bits with the remaining half of the ULTPC bits preserves the UL power-control rate, but may instead impact the ULTPC demodulation performance. This impact can be eliminated by appropriately increasing the ULTPC transmit power to compensate for the reduced number of ULTPC bits. Such an increase does not affect the ULTPC bit decoding performance when a Nack has to be sent, if on-off keying is used. However, when the Ack has to be sent, receiver imperfections such as channel estimation errors, frequency offsets and I-Q phase imbalances may cause degradation in the ULTPC bit demodulation. This degradation may be acceptable since it only happens infrequently, as the Ack can be sent only once or only a few times per packet.

Another way to address this potential degradation is to have the packet transmitting device that receives the Ack declare a ULTPC bit erasure whenever an Ack is detected, as described in connection with FIG. 6.

Thus, a fixed, known phaseshift may be applied to a modulation constellation formed after the bits are I-Q multiplexed. For example, when two TPC bits are comprised in a slot, and one of them is replaced by Ack, the TPC bit and the Ack bit may be IQ multiplexed, as in the traditional interpretation of IQ multiplexing (one bit on I, one bit on Q). When the two TPC bit positions both have the same value, TPC uses a 45 degree rotated BPSK constellation. Another way of achieving the IQ multiplexing is to add a new Ack symbol which uses its own BPSK or on-off keying constellation which is a further 90 degree rotated version of the TPC BPSK constellation. These implementations of IQ-multiplexing are similar except that one has a fixed overall phase-shift of the constellation relative to the other.

The transmission at 516 may comprise a different transmit power offset between the TPC bits and Ack bits in the slots where the Ack is transmitted. Thus, the ULTPC bits may be transmitted at a higher power in slots where an Ack needs to be sent as compared to the transmission power used in slots where a Nack needs to be sent. This difference may be known to the packet transmitting device that receives the Ack. This enables the packet transmitting device to account for the power difference in other algorithms that may use the ULTPC bits, e.g., an SNR estimation for DL power control.

The power offsets to be used when Ack is sent can depend on at least one of a type of the packet being acknowledged and a time that the Ack is transmitted. The type of the packet may comprise, e.g., a size of the packet, and the time that the Ack is transmitted may indicates a correspondence between the time that the packet was decoded measured relative to a start of the packet

The Ack may be sent only once per successful decoding of the packet. For example, aspects may include sending “Off” transmissions after an “On” transmission until the end of the packet. These “Off” transmissions do not signify Nack, but can instead be ignored by the packet transmitting device receiving the Ack/Nack because the early decoding of the packet has already been acknowledged.

Alternately, the Ack may be sent multiple times per successful decoding of the packet. This may increase the reliability of reception of the Ack.

In another aspect, the Ack may be repeated only in certain circumstances. Thus, the device may determine at 518 whether to send an additional Ack. The determination may be based on whether transmission of the packet has ceased. Thus, the device may determine whether or not the previous Ack was received correctly before transmitting an additional Ack. Such a determination may be made by continuing to monitor an energy of the received pack after it has been decoded in order to determine whether the packet transmitter has stopped the packet transmission in response to the previous Ack. In an aspect, the determination regarding whether to send an additional Ack may be performed by an Ack/Nack determination module, e.g., 710 as illustrated in connection with FIG. 7.

When the Ack is transmitted on the separate R99 DL channel using resources of another existing DL control channel at 508, the existing DL control channel may comprise an F-DPCH channel at 520. A subset of F-DPCH bit positions may be reserved for the Ack. The packet that is early decoded may be received on an R99 uplink channel.

Alternately, the existing DL channel may comprise an E-HICH or E-RGCH channel at 522. This may include having a pre-configured signature sequence reserved for the Ack.

The duration of the E-HICH transmission may comprise a pre-configured duration comprising one of one slot, two slots, and three slots.

FIG. 6 is a flow chart of a method 600 of wireless communication. The method may be performed by a wireless device that transmits packets of wireless communication, such as a UE or Node B. In an aspect, the device may be apparatus 802 as described in connection with FIG. 8. The device may transmit the packets to a receiving device, e.g., 850 in FIG. 8 or 702 in FIG. 7.

At 602, the device begins a transmission of a packet. In an aspect, this transmission may be performed by a transmission module, e.g. 808 illustrated in FIG. 8.

At 604, the device receives an Ack of early decoding prior to transmission of the entire packet. The Ack is received from the receiving device, e.g., 850, to which the packet is being transmitted. The Ack indicates that the receiving device 850 has already decoded the packet prior to receiving the entire packet. As described in more detail in connection with FIG. 5, the Ack may be received as a transmission having on/off keying or BPSK and using a slot format that substitutes Ack bits in a subset of slots reserved for ULTPC, or the Ack may be received as a transmission on a separate R99 DL channel using resources of another existing DL control channel. In an aspect, this reception may be performed by a reception module, e.g., 804 illustrated in FIG. 8.

At 606, the device ceases transmission of the packet after receiving the Ack. Thus, the transmission module, e.g., 808, ceases transmission of the packet once it has received an indication from the receiving device that the packet has already been decoded. This reduces the power required to transmit the packet and increases system capacity.

When the Ack is received on the separate R99 DL channel using resources of another existing DL control channel, the existing channel may comprise an F-DPCH channel, wherein a subset of F-DPCH bit positions are used for the Ack. Alternately, the existing DL channel may comprise one of an E-HICH and an E-RGCH, wherein a pre-configured signature sequence is used for the Ack. A duration of the E-HICH transmission may include a pre-configured duration comprising one, two, or three slots. The packet that is early decoded may be received on an R99 UL channel.

When the Ack is received as a transmission having on/off keying or BPSK and having a slot format that substitutes Ack bits in a subset of slots reserved for ULTPC the device may determine the Ack based on at least one of an energy detection at 608 and coherent modulation using channel estimates at 610. Thus, even though on/off keying or BPSK is used in sending the transmission, the device may detect an Ack/Nack using more than energy detection. This may include coherent demodulation using channel estimates, e.g., as used for demodulation of other control and data channels. In an aspect, the detection may be performed by an Ack/Nack detecting module, e.g., 810 illustrated in FIG. 8.

The Ack bits may replace all of a set of TPC bits, ULTPC bits, in a slot having bits reserved for TPC or may replace only a subset of TPC bits in a slot having bits reserved for such TPC bits.

When the Ack bits replace all of a set of TPC bits of a slot having bits reserved for TPC bits, the Ack may replace such bits, e.g., in alternate slot. Alternately, the Ack may replace TPC bits in fewer slots, such as at most every third TPC slot having bits reserved for TPC.

When the Ack bits replace a subset of TPC bits of a slot having bits reserved for ULTPC bits, the subset of the TPC bits replaced by Ack bits may comprise half of the bits. The Ack bits may be I-Q multiplexed with the remaining half of the TPC bits. Receiving this type of Ack may affect ULTPC demodulation performance, for example, receiver imperfections such as channel estimation errors, frequency offsets and I-Q phase imbalances may cause degradation in the ULTPC bit demodulation. In an aspect, this degradation may be reduced by declaring a ULTPC erasure whenever an Ack is detected. Thus, the device may further determine at 612 an erasure of ULTPC bits when an Ack is detected in the same slot as a slot reserved for ULTPC bits. In an aspect, this determination may be performed by an Ack/Nack detecting module, such as 810 illustrated in FIG. 8.

The Ack may be received as a transmission comprising a different transmit power offset between ULTPC bits and Ack bits in the slot compared to the slots in which a Nack is transmitted. This transmit power offset may be known to the device. Thus, the device may use the known, preconfigured transmit power offset to detect at 614 an increased ULTPC transmission power in slots having an Ack. In an aspect, this determination may be performed by Ack/Nack detecting module, e.g., 810 illustrated in FIG. 8.

The Ack may comprise a fixed, known phaseshift is applied to a modulation constellation after the bits are I-Q multiplexed. The received transmission including an Ack may comprise a different transmit power offset between the TPC bits and Ack bits in the slots when the Ack is received. Power offsets used when an Ack is sent may depend on at least one of a type of the packet being acknowledged and a time that the Ack is transmitted. The type of the packet may comprise a size of the packet, and the time that the Ack is transmitted may indicate a correspondence between the time that the packet was decoded measured relative to a start of the packet. An Ack transmission may comprise a power offset for TPC, and the power offset may be based on information multiplexed with the TPC.

As described supra in connection with 518 of FIG. 5, an Ack might be sent only once. Therefore, the device may receive at least one Nack after receiving an Ack. Such “off” transmissions after an “On” transmission do not indicate that the packet has not been decoded, but are intended to be ignored since the packet has already been acknowledged. This reduces the impact of degradations caused by the Ack because it is sent only once, or only a few times, per packet transmission. Thus, at 616, the device may disregard a Nack received after receipt of the Ack. In an aspect, this determination to disregard a Nack may be performed by Ack/Nack detecting module, e.g., 810 illustrated in FIG. 8.

FIG. 7 is a conceptual data flow diagram 700 illustrating the data flow between different modules/means/components in an exemplary apparatus 702. The apparatus may be a device that receives wireless communication of packets, as described in connection with aspects of FIG. 5. The device may be, e.g., a UE or a Node B. The apparatus 702 includes a reception module 704 that receives packets from a transmitting device 750. The transmitting device is a device that transmits packets of wireless communication, e.g., a UE or a Node B. The apparatus 702 includes a decoding module 706 that attempts to early decode the packet prior to reception of the entire packet, and a transmission module 708 that transmits an Ack of early decoding once the early decoding has been performed. The Ack is transmitted to transmitting device 750. The Ack may be transmitted using one of on/off keying or BPSK and using a slot format that substitutes Ack bits in a subset of slots reserved for ULTPC, and an R99 DL channel for traffic packets sent on an R99 UL channel, by using resources of another existing DL control channel, as described in connection with FIG. 5.

The apparatus 702 may further include an Ack/Nack determination module 710 that determines whether to transmit an Ack after early decoding the packet. The determination may be made prior to the transmission of the Ack by the transmission module 708. The Ack/Nack determination module may determine whether to send the Ack based on whether the apparatus has sufficient transmit power to transmit the Ack. The Ack/Nack determination module may determine whether to send the Ack based on whether the Ack will be received by the transmitting device 750 more than a predetermined amount of time from the end of the transmission of the packet.

The Ack/Nack determination module 710 may also determine whether to repeat an Ack. The determination may be based on whether the previous Ack was received, e.g., this may include a further determination of whether transmission of the packet by transmitting device 750 has ceased.

The apparatus may include additional modules that perform each of the steps of the algorithm in the aforementioned flow charts of FIG. 5. As such, each step in the aforementioned flow charts of FIG. 5 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

FIG. 8 is a conceptual data flow diagram 800 illustrating the data flow between different modules/means/components in an exemplary apparatus 802. The apparatus 802 may be a device that transmits packets of wireless communication, as described in connection with aspects of FIG. 6. The device may be, e.g., a UE or a Node B. The apparatus 802 includes a transmission module 808 that transmits packets to a receiving device 850. The receiving device is a device that receives packets of wireless communication, e.g., a UE or a Node B. The receiving device 850 may be similar to apparatus 702 described in connection with FIG. 7.

The apparatus 802 also includes a reception module 804 that receives an Ack of early decoding from receiving device 850 prior to transmission of the entire packet by transmission module 808. The Ack can be received as one of a transmission having on/off keying or BPSK and using a slot format that substitutes Ack bits in a subset of slots reserved for ULTPC and a transmission on a R99 DL channel for traffic packets sent on the R99 UL channel, by using resources of another existing DL control channel.

Once an Ack is received, the transmission module 808 ceases transmission of the packet. The apparatus may further comprise an Ack/Nack detecting module 810 that determines an Ack based on at least one of an energy detection and coherent modulation using channel estimates. The Ack/Nack detecting 810 may determine an erasure of ULTPC bits when an Ack is determined to have been received in the same slot. The Ack/Nack detecting module 810 may use a known, pre-configured transmit power offset to detect an increased ULTPC transmission in slots having an Ack, e.g., when a received transmission comprises a different transmit power offset between ULTPC bits and Ack bits in the slot compared to the slots in which Nack is transmitted. The Ack/Nack detecting module 810 may disregard a Nack received after an Ack has been detected.

The apparatus may include additional modules that perform each of the steps of the algorithm in the aforementioned flow charts of FIG. 6. As such, each step in the aforementioned flow charts of FIG. 6 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

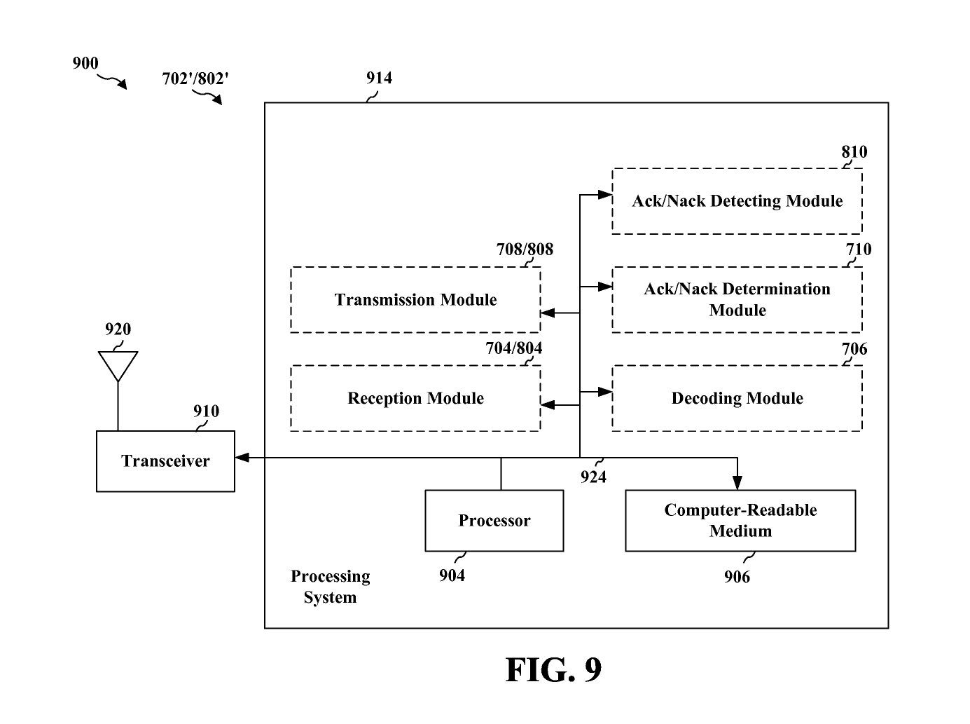

As illustrated in FIG. 9, a single apparatus may include both the modules for the reception functions of early decoding and the transmission functions related to early decoding, e.g., a single apparatus may include the modules to send Acks of early decoding and to receive such Acks.

FIG. 9 is a diagram 900 illustrating an example of a hardware implementation for an apparatus 702′/802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 904, the modules 704, 706, 708, 710, 804, 808, and 810, and the computer-readable medium 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The processing system 914 includes a processor 904 coupled to a computer-readable medium 906. The processor 904 is responsible for general processing, including the execution of software stored on the computer-readable medium 906. The software, when executed by the processor 904, causes the processing system 914 to perform the various functions described supra for any particular apparatus. The computer-readable medium 906 may also be used for storing data that is manipulated by the processor 904 when executing software. The processing system further includes at least one of the modules 704, 706, 708, 710, 804, 808, and 810. The modules may be software modules running in the processor 904, resident/stored in the computer readable medium 906, one or more hardware modules coupled to the processor 904, or some combination thereof. When apparatus 702′ or 802′ is a Node B, the processing system 914 may be a component of the Node B 410 and may include the memory 442 and/or at least one of the TX processor 420, the RX processor 438, and the controller/processor 440. When apparatus 702′ or 802′ is a UE, the processing system 914 may be a component of the UE 450 and may include the memory 492 and/or at least one of the TX processor 480, the RX processor 470, and the controller/processor 490.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of wireless communication, comprising:
early decoding a packet prior to reception of the entire packet; and
transmitting an acknowledgement (Ack) of early decoding, wherein the Ack is transmitted using one of
on/off keying or binary phase-shift keying (BPSK) and using a slot format that substitutes Ack bits in a subset of slots reserved for uplink transmitter power control (ULTPC), and
a separate R99 downlink channel.

2. The method of claim 1, further comprising:
determining whether to transmit an Ack after early decoding, the determination being made prior to transmitting the Ack of early decoding.

3. The method of claim 1, wherein the determination is based on whether sufficient transmit power is available to transmit the Ack.

4. The method of claim 1, wherein the determination is based on whether the Ack will be received within less than a predetermined time period from the end of the transmission of the packet.

5. The method of claim 4, wherein the determination accounts for an amount of time used to decode the packet and an amount of time required to receive the Ack.

6. The method of claim 1, wherein the Ack is transmitted using on/off keying or BPSK and using the slot format that substitutes Ack bits in place of ULTPC bits in a subset of slots having bits reserved for ULTPC.

7. The method of claim 6, wherein the Ack bits replace all of a set of TPC bits of a slot having bits reserved for ULTPC.

8. The method of claim 7, wherein the Ack replaces ULTPC bits in every alternate slot.

9. The method of claim 7, wherein the Ack replaces ULTPC bits in at most every third slot.

10. The method of claim 6, wherein the Ack bits replace a subset of TPC bits of a slot having bits reserved for ULTPC bits.

11. The method of claim 10, wherein the subset of the TPC bits replaced by Ack bits comprises one half of the bits, and wherein the Ack bits are in-phase-quadrature phase (I-Q) multiplexed with the remaining half of the TPC bits.

12. The method of claim 11, wherein a fixed, known phaseshift is applied to a modulation constellation formed after the bits are I-Q multiplexed.

13. The method of claim 11, wherein the transmission comprises a different transmit power offset between the TPC bits and Ack bits in the slots where the Ack is transmitted.

14. The method of claim 11, wherein the power offsets to be used when Ack is sent depends on at least one of a type of the packet being acknowledged and a time that the Ack is transmitted.

15. The method of claim 14, wherein the type of the packet comprises a size of the packet, and wherein the time that the Ack is transmitted indicates a correspondence between the time that the packet was decoded measured relative to a start of the packet.

16. The method of claim 11, wherein the transmission comprises a power offset for TPC, wherein the power offset is based on information multiplexed with the TPC.

17. The method of claim 16, wherein the power offsets to be used when Ack is sent depends on at least one of a type of the packet being acknowledged and a time that the Ack is transmitted.

18. The method of claim 17, wherein the type of the packet comprises a size of the packet, and wherein the time that the Ack is transmitted indicates a correspondence between the time that the packet was decoded measured relative to a start of the packet.

19. The method of claim 6, wherein the Ack is sent only once per successful early decoding of the packet.

20. The method of claim 6, wherein the Ack is sent multiple times per successful early decoding of the packet.

21. The method of claim 20, further comprising:
determining whether to repeat an Ack based on whether transmission of the packet has ceased.

22. The method of claim 1, wherein the Ack is transmitted on the separate R99 downlink channel using resources of an existing downlink control channel, and wherein the packet that is early decoded is received on an R99 uplink channel.

23. The method of claim 22, where the existing downlink control channel comprises a fractional dedicated physical channel (F-DPCH), and wherein a subset of F-DPCH bit positions are reserved for the Ack.

24. The method of claim 22, where the existing downlink channel comprises one of an enhanced dedicated channel hybrid automatic repeat request acknowledgement indicator channel (E-HICH) and an enhanced dedicated channel relative grant channel (E-RGCH), and wherein a pre-configured signature sequence is reserved for the Ack.

25. The method of claim 24, wherein the duration of the E-HICH transmission comprises a pre-configured duration comprising one of one slot, two slots, and three slots.

26. The method of claim 1, where a selection of one of on-off keying and BPSK is based on at least one of a type of the packet being acknowledged and a time that the Ack is transmitted.

27. The method of claim 26, wherein the type of the packet comprises a size of the packet, and wherein the time that the Ack is transmitted indicates a correspondence between the time that the packet was decoded measured relative to a start of the packet.

28. An apparatus comprising:
an decoder configured to early decode a packet prior to reception of the entire packet; and
a transmitter configured to transmit an acknowledgement (Ack) of early decoding, wherein the Ack is transmitted using one of
on/off keying or binary phase-shift keying (BPSK) and using a slot format that substitutes Ack bits in a subset of slots reserved for uplink transmitter power control (ULTPC), and
a separate R99 downlink channel.

29. The apparatus of claim 28, wherein the transmitter determines whether to transmit an Ack after early decoding, the determination being made prior to transmitting the Ack of early decoding.

30. The apparatus of claim 28, wherein the determination is based on whether sufficient transmit power is available to transmit the Ack.

31. The apparatus of claim 28, wherein the determination is based on whether the Ack will be received within less than a predetermined time period from the end of the transmission of the packet.

32. The apparatus of claim 28, wherein the Ack is transmitted using on/off keying or BPSK and using the slot format that substitutes Ack bits in place of ULTPC bits in a subset of slots having bits reserved for ULTPC.

33. The apparatus of claim 32, wherein the Ack bits replace all of a set of TPC bits of a slot having bits reserved for ULTPC.

34. The apparatus of claim 32, wherein the Ack bits replace a subset of TPC bits of a slot having bits reserved for ULTPC bits.

35. The apparatus of claim 34, wherein the subset of the TPC bits replaced by Ack bits comprises one half of the bits, and wherein the Ack bits are in-phase-quadrature phase (I-Q) multiplexed with the remaining half of the TPC bits.

36. The apparatus of claim 32, wherein the Ack is sent only once per successful early decoding of the packet.

37. The apparatus of claim 32, wherein the Ack is sent multiple times per successful early decoding of the packet.

38. The apparatus of claim 37, wherein the transmitter determines whether to repeat an Ack based on whether transmission of the packet has ceased.

39. The apparatus of claim 28, wherein the Ack is transmitted on the separate R99 downlink channel using resources of an existing downlink control channel, and wherein the packet that is early decoded is received on an R99 uplink channel.

40. The apparatus of claim 39, where the existing downlink control channel comprises a fractional dedicated physical channel (F-DPCH), and wherein a subset of F-DPCH bit positions are reserved for the Ack.

41. The apparatus of claim 39, where the existing downlink channel comprises one of an enhanced dedicated channel hybrid automatic repeat request acknowledgement indicator channel (E-HICH) and an enhanced dedicated channel relative grant channel (E-RGCH), and wherein a pre-configured signature sequence is reserved for the Ack.

42. The apparatus of claim 28, where a selection of one of on-off keying and BPSK is based on at least one of a type of the packet being acknowledged and a time that the Ack is transmitted.

43. The apparatus of claim 42, wherein the type of the packet comprises a size of the packet, and wherein the time that the Ack is transmitted indicates a correspondence between the time that the packet was decoded measured relative to a start of the packet.

44. A computer program product, comprising:
a computer-readable medium comprising:
a first set of codes for causing a computer to early decode a packet prior to reception of the entire packet; and
a second set of codes for causing a computer to transmit an acknowledgement (Ack) of early decoding, wherein the Ack is transmitted using one of
on/off keying or binary phase-shift keying and using a slot format that substitutes Ack bits in a subset of slots reserved for uplink transmitter power control (ULTPC), and
a separate R99 downlink channel.

45. An apparatus, comprising:
means for early decoding a packet prior to reception of the entire packet; and
means for transmitting an acknowledgement (Ack) of early decoding, wherein the Ack is transmitted using one of
on/off keying or binary phase-shift keying and using a slot format that substitutes Ack bits in a subset of slots reserved for uplink transmitter power control (ULTPC), and
a separate R99 downlink channel.

46. A method of wireless communication comprising:
beginning a transmission of a packet; and
receiving an acknowledgement (Ack) of early decoding prior to transmission of the entire packet, wherein the Ack is received as one of
a transmission having on/off keying or binary phase-shift keying (BPSK) and using a slot format that substitutes Ack bits in a subset of slots reserved for uplink transmitter power control (ULTPC), and
a transmission on a separate R99 downlink channel; and
ceasing transmission of the packet after receiving the Ack.

47. The method of claim 46, wherein the Ack is received as a transmission having on/off keying and having a slot format that substitutes Ack bits in a subset of slots reserved for ULTPC.

48. The method of claim 47, wherein the Ack is determined based on an energy detection.

49. The method of claim 48, wherein the Ack is further determined based on coherent modulation using channel estimates.

50. The method of claim 47, wherein the Ack is received on an R99 downlink channel, and wherein the packet is transmitted on an R99 uplink channel.

51. The method of claim 47, wherein the Ack bits replace all of a set of TPC bits of a slot having bits reserved for ULTPC.

52. The method of claim 51, wherein the Ack replaces ULTPC bits in every alternate slot.

53. The method of claim 51, wherein the Ack replaces ULTPC bits on at most every third slot.

54. The method of claim 47, wherein the Ack bits replace a subset of TPC bits of a slot having bits reserved for ULTPC.

55. The method of claim 54, further comprising:
determining an erasure of ULTPC bits when an ACK is detected in the same slot.

56. The method of claim 54, wherein the subset of the TPC bits replaced by Ack bits comprises one half of the bits, and wherein the Ack bits are in-phase-quadrature phase (I-Q) multiplexed with the remaining half of the TPC bits.

57. The method of claim 56, wherein the Ack comprises a fixed, known phaseshift is applied to a modulation constellation after the bits are I-Q multiplexed.

58. The method of claim 56, wherein a received transmission comprises a different transmit power offset between the TPC bits and Ack bits in the slots when the Ack is received.

59. The method of claim 56, wherein the power offsets used when the Ack is sent depend on at least one of a type of the packet being acknowledged and a time that the Ack is transmitted.

60. The method of claim 59, wherein the type of the packet comprises a size of the packet, and wherein the time that the Ack is transmitted indicates a correspondence between the time that the packet was decoded measured relative to a start of the packet

61. The method of claim 56, wherein the received Ack transmission comprises a power offset for TPC, wherein the power offset is based on information multiplexed with the TPC.

62. The method of claim 61, wherein the power offsets used when the Ack is sent depend on at least one of a type of the packet being acknowledged and a time that the Ack is transmitted.

63. The method of claim 62, wherein the type of the packet comprises a size of the packet, and wherein the time that the Ack is transmitted indicates a correspondence between the time that the packet was decoded measured relative to a start of the packet.

64. The method of claim 47, wherein one Ack is received per successful early decoding of the packet, the method further comprising:
disregarding a negative acknowledgement (Nack) received after the Ack.

65. The method of claim 46, wherein the Ack is received on the separate R99 downlink channel using resources of an existing downlink control channel, and
wherein the packet is transmitted on an R99 uplink channel.

66. The method of claim 65, where the existing downlink control channel comprises a fractional dedicated physical channel (F-DPCH), and wherein a subset of F-DPCH bit positions are reserved for the Ack.

67. The method of claim 66, where the existing downlink channel comprises one of an enhanced dedicated channel hybrid automatic repeat request acknowledgement indicator channel (E-HICH) and an enhanced dedicated channel relative grant channel (E-RGCH), and wherein a pre-configured signature sequence is reserved for the Ack.

68. The method of claim 67, wherein the duration of the E-HICH transmission comprises a pre-configured duration comprising one of one slot, two slots, and three slots.

69. An apparatus, comprising:
a transmitter configured to begin a transmission of a packet; and
a receiver configured to receive an acknowledgement (Ack) of early decoding prior to transmission of the entire packet, wherein the Ack is received as one of
a transmission having on/off keying or binary phase-shift keying (BPSK) and using a slot format that substitutes Ack bits in a subset of slots reserved for uplink transmitter power control (ULTPC), and
a transmission on a separate R99 downlink channel,
wherein the transmitter is configured to cease transmission of the packet after receiving the Ack.

70. The apparatus of claim 69, wherein the Ack is received as a transmission having on/off keying and having a slot format that substitutes Ack bits in a subset of slots reserved for ULTPC.

71. The apparatus of claim 70, wherein the Ack is determined based on an energy detection.

72. The apparatus of claim 70, wherein the Ack is received on an R99 downlink channel, and wherein the packet is transmitted on an R99 uplink channel.

73. The apparatus of claim 70, wherein the Ack bits replace all of a set of TPC bits of a slot having bits reserved for ULTPC.

74. The apparatus of claim 70, wherein the Ack bits replace a subset of TPC bits of a slot having bits reserved for ULTPC.

75. The apparatus of claim 74, wherein the receiver is further configured to determine an erasure of ULTPC bits when an ACK is detected in the same slot.

76. The apparatus of claim 74, wherein the subset of the TPC bits replaced by Ack bits comprises one half of the bits, and wherein the Ack bits are in-phase-quadrature phase (I-Q) multiplexed with the remaining half of the TPC bits.

77. The apparatus of claim 70, wherein one Ack is received per successful early decoding of the packet, wherein the receiver is further configured to disregard a negative acknowledgement (Nack) received after the Ack.

78. The apparatus of claim 69, wherein the Ack is received on the separate R99 downlink channel using resources of an existing downlink control channel, and
wherein the packet is transmitted on an R99 uplink channel.

79. The apparatus of claim 78, where the existing downlink control channel comprises a fractional dedicated physical channel (F-DPCH), and wherein a subset of F-DPCH bit positions are reserved for the Ack.

80. The apparatus of claim 79, where the existing downlink channel comprises one of an enhanced dedicated channel hybrid automatic repeat request acknowledgement indicator channel (E-HICH) and an enhanced dedicated channel relative grant channel (E-RGCH), and wherein a pre-configured signature sequence is reserved for the Ack.

81. A computer program product configured to receive an acknowledgment (Ack) of early decoding, comprising:
a computer-readable medium comprising:
a first set of codes for causing a computer to begin a transmission of a packet; and
a second set of codes for causing a computer to receive an acknowledgement (Ack) of early decoding prior to transmission of the entire packet, wherein the Ack is received as one of
a transmission having on/off keying or binary phase-shift keying (BPSK) and using a slot format that substitutes Ack bits in a subset of slots reserved for uplink transmitter power control (ULTPC), and
a transmission on a separate R99 downlink channel; and
ceasing transmission of the packet after receiving the Ack.

82. An apparatus, comprising:
means for beginning a transmission of a packet; and
means for receiving an acknowledgement (Ack) of early decoding prior to transmission of the entire packet, wherein the Ack is received as one of
a transmission having on/off keying or binary phase-shift keying (BPSK) and using a slot format that substitutes Ack bits in a subset of slots reserved for uplink transmitter power control (ULTPC), and
a transmission on a separate R99 downlink channel; and
ceasing transmission of the packet after receiving the Ack.
